(19) United States
(12) Patent Application Publication
(10) Pub. No.: US 2013/0105390 A1
(43) Pub. Date: May 2, 2013

(54) Low Mean Cell Residence Time Anaerobic Digestion Process

(71) Applicants: Donald M. D. Gray, Oakland, CA (US); Yuyun Shang, Walnut Creek, CA (US)

(72) Inventors: Donald M. D. Gray, Oakland, CA (US); Yuyun Shang, Walnut Creek, CA (US)

(21) Appl. No.: 13/287,969

(22) Filed: Nov. 2, 2011

(51) Int. Cl. C02F 3/28; C02F 101/32; C02F 103/22; C02F 101/30

(52) U.S. Cl. 210/613

(57) ABSTRACT

A Class B biosolids sludge digestion process whereby feed sludge is introduced to a completely-mixed, continuously- or intermittently fed and drawn, sealed, anaerobic digester, and sludge is drawn off at a rate such that the average mean cell residence time for the sludge in the digester is greater than or equal to 10 days, and less than 15 days. The temperature of the sludge is maintained in the thermophilic range to produce treated sludge having: a volatile solids content that is at least 38% less than the volatile solids content of the feed sludge, a reduced fecal coliform content that is at least a 2 log (base 10) reduction from the feed sludge, and where there is no more than 2,000,000 most probable number/gram total solids (dry weight basis) of fecal coliform in the treated sludge.

### BACKGROUND OF THE INVENTION

This invention relates generally to a method and system for the anaerobic treatment of wastewater or sludge. In particular, this invention relates to a method for the economical production of Class B biosolids by feeding an anaerobic digester and treating the waste stream at a specific thermophilic temperature range, for a mean cell residence time (MCRT) less than 15 days.

A typical wastewater treatment facility accepts input wastewater containing solid and dissolved waste matter from municipal or industrial sources. The solids and dissolved matter are removed, and the water is purified prior to discharge into the environment. The waste solids are commonly referred to as sludge or biosolids. A sludge is typically a solids-liquid mixture characterized by a solids phase and an associated liquid phase, and the solids are at least partially biodegradable. Biodegradable sludges are generally characterized according to their Volatile Solids (VS) content and their Chemical Oxygen Demand (COD). Treated sludges are also characterized by their tendency to attract animal and insect vectors and must usually meet a Vector Attraction Reduction Requirement (VAR) if the sludge will be disposed of by application to land. Waste stream sludges may contain viral, protozoan, and bacterial pathogens, organic and inorganic contaminants, and have a high organic content. As such care must be taken in their disposal.

In 1993, the U.S. Environmental Protection Agency promulgated “Sewage Sludge” regulations that set limits on the manner in which sludge and biosolids from wastewater streams and other sources can be disposed of or used (40 Code of Federal Regulations Part 503). Under the regulations, treated sludge is divided into two classes with different uses or disposal methods being available, depending on whether the sludge meets Class A or Class B requirements, with Class A requirements being more stringent. Class B biosolids must be treated both to reduce their organic content and their pathogen content. In particular at least a 2 log (base 10) reduction in fecal coliform must be achieved. Furthermore, fecal coliform must be reduced in the treated sludge such that the geometric mean of seven samples taken from the treated sludge can be no more than 2,000,000 most probable number/g total solids (dry weight basis of the total solids) of fecal coliform; and greater than 38% of the volatile solids in the sludge must be destroyed (this is known as Volatile Solids Reduction in mass (VSR)). Meeting Class B pathogen standards, vector attraction requirements, and pollutant limits allows wastewater treatment agencies to land apply their biosolids on fields as long as specific site restrictions are met.

The EPA regulations set parameters for five different processes that can meet Class B pathogen standards. Mesophilic anaerobic digestion has been one of the most widely used Class B processes for stabilization of primary and secondary sludges produced at municipal wastewater treatment facilities. The mesophilic temperature range has been characterized as lying between 25° C. and 45° C. Organisms that prefer and are active at the higher temperature range of 45° C. to 65° C. are considered to be thermophilic. Temperature can have an effect on the rate of pathogen reduction in both the mesophilic and thermophilic temperature ranges. In certain cases reaction rates increase with temperature increases; however, past a certain temperature point reaction rates decrease or stop altogether as the temperature becomes too high for the particular organisms driving the reaction.

Mesophilic anaerobic digestion reduces the organic content of sewage sludge by conversion of organic material to methane through the actions of facultative and anaerobic bacteria. In practice, an anaerobic digester is operated by introducing relatively small volumes of raw sludge to a digester/reactor vessel containing a relatively much larger volume of sludge within which the necessary ecology has been established and is maintained, displacing a similarly small volume of digested sludge in the process. This may either be a continuous process or an intermittent process. The amount of raw sludge introduced to the reactor has to be relatively small in comparison to the volume of the reactor to ensure that the necessary conditions for the ongoing digestion are maintained. Raw sewage sludges introduced into the reactor are completely mixed and the average time any particular particle or volume of sewage sludge spends in the reactor is referred to as the retention time, commonly referred to as the Mean Cell Residence Time (MCRT).

The processes which occur in a traditional mesophilic anaerobic digestion process are well documented. Essentially the digestion process is considered to involve three steps: a first step of solubilization of solids by enzymes; a second step of bacterial synthesis of fatty acids (acidogenesis); and finally a third step of gasification by methane-forming bacteria (methanogenesis). The anaerobic digestion process is considered stable when there is a proper balance between acidogenesis and methanogenesis. Acidogenesis produces volatile organic acids such as acetic, propionic, and butyric acids, which decrease digester sludge pH and alkalinity. Conversely, methanogenesis consumes these acids converting them into methane and carbon dioxide and consequently increases both pH and alkalinity. A well operating stable digester is one that has a low volatile acid to alkalinity ratio, typically less than 0.10. The inventors have found that the anaerobic digestion process can be stable at volatile acid to alkalinity ratios of 0.40.

While mesophilic anaerobic digestion is commonly used to achieve Class B biosolids, it has two major drawbacks. Reaction rates are slow and pathogens are often not killed. Current regulations require a minimum mean cell residence time of 15 days. This means treatment plants need large capacity digestion tanks to be able to hold the waste long enough to treat it properly. As municipalities grow this is putting pressure on municipalities to raise capital and find space to increase treatment capacities. The volatile solids reduction rate is slowed by even small additions of biological solids, particularly waste activated sludge (WAS).

The inventors of the present invention realized that if they could operate anaerobic digesters at a shorter mean cell residence time/increased digester feed rates, while still meeting Class B standards, they would have a relatively quick and inexpensive way to significantly increase digester capacity.

The basic aim of the current sludge treatment process is to economically and efficiently reduce and stabilize sludge solids, producing an end product that is suitable for disposal by land spreading after it has been dewatered.

### SUMMARY OF THE INVENTION

The present invention provides a one stage process consisting of a complete-mix, thermophilic anaerobic digester with continuous or intermittent feed and withdrawal, and treating the raw sludge at a specific temperature of between 47° C. to 53° C., and disposing of the treated wastewater sludge as a Class B biosolid.

This invention provides a method of treating a waste stream using an anaerobic digestion process that has a much shorter MCRT than that required by the Environmental Protection Agency (EPA), as stated in 40 CFR §503.33(b)(3) Class B—Alternative 2.

The present invention provides an approach to achieving the Class B criteria with thermophilic anaerobic digestion. The process uses a complete-mix, continuous-flow digester for a mean cell residence time below 15 days.

The present invention provides a method of treating a waste stream using an anaerobic digestion process that meets the following Process to Significantly Reduce Pathogens (PSRP) equivalency criteria for Class B biosolids and Vector Attraction Reduction requirement by the U.S. EPA Pathogen Equivalency Committee (PEC): 2 log (base 10) reduction in fecal coliform; geometric mean of seven samples 2,000,000 most probable number/gram total solids (dry weight basis) of fecal coliform in the treated sludge; and a greater than 38% Volatile Solids Reduction in mass.

It is a further object of the present invention to increase digester capacity by reducing mean cell residence time in an anaerobic digester, while being able to treat sludge having a large proportion which is waste activated sludge.

### BRIEF DESCRIPTION OF THE FIGURES

FIG. 1 is top, cross sectional view of a digester used in the method of the present invention with conduits shown as arrows.

FIG. 2 is a side, cross-sectional view of a digester used in the method of the present invention.

FIG. 3 is a simplified schematic showing the digester, heat exchanger and recirculation pump of the present invention with inflow, outflow and recirculation conduits shown as arrows.

### DETAILED DESCRIPTION OF THE INVENTION

The sludge digestion process of this invention requires introducing feed sludge having a total solids concentration of less than or equal to 10% to a completely-mixed, continuously-stirred, sealed, anaerobic digester 1, and drawing off sludge from the digester 1 at a rate such that the mean cell residence time for the sludge in the digester 1 is greater than or equal to 10 days, and less than 15 days, while preferably maintaining the temperature of the sludge in the digester 1 in the range of from 47° C. to 53° C., to produce treated sludge having: a volatile solids content that is 38% less than the volatile solids content of the feed sludge introduced to the digester 1, a reduced fecal coliform content that is a 2 log (base 10) reduction from the feed sludge introduced to the digester 1, and where a geometric mean of seven samples of the treated sludge shows that there is no more than 2,000,000 most probable number/gram total solids (dry weight basis) of fecal coliform in the treated sludge.

The thermophilic temperature under which the anaerobic digestion takes place is very important in achieving the reduced mean cell residence times for the sludge in the digester 1 of the present invention. Ideally the temperature is maintained at 50° C. and fluctuates no more than 3° C. above or below this temperature, but temperatures up to 65° C. would likely be suitable if desired. The pH of the sludge in the digester 1 is also preferably maintained between 6.5 and 8.5 standard units, and the total volatile acid to alkalinity ratio is less than 0.4.

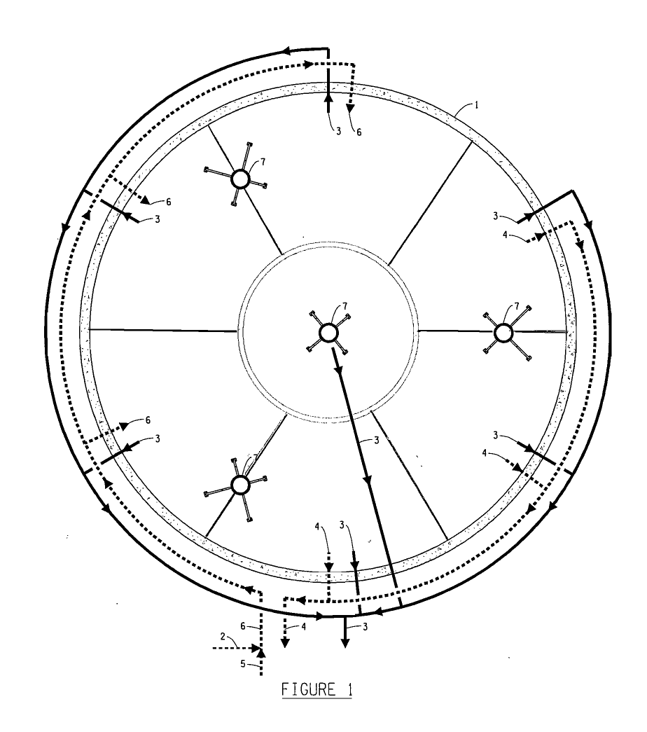

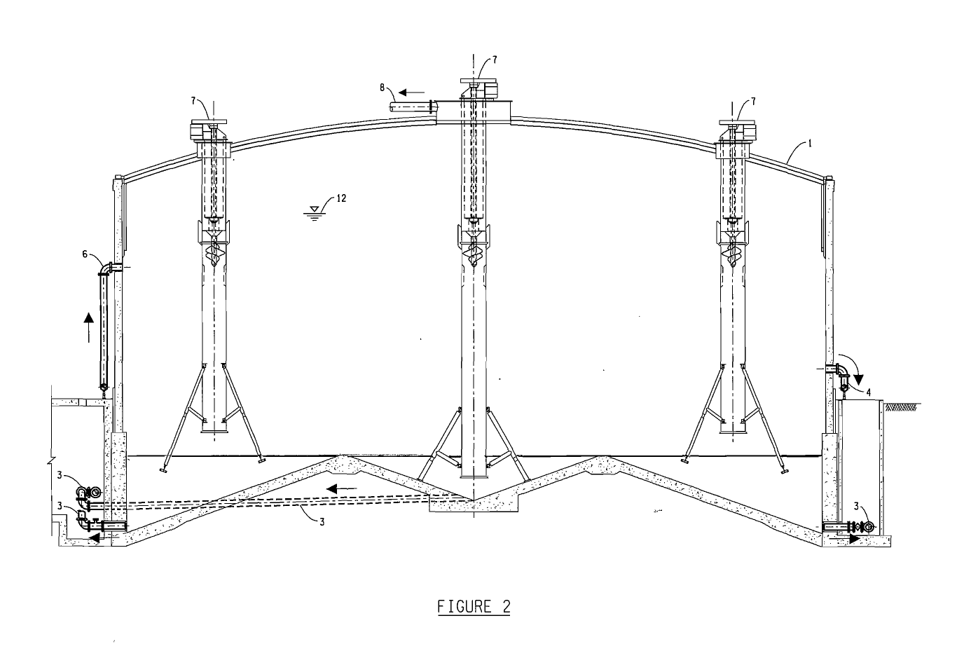

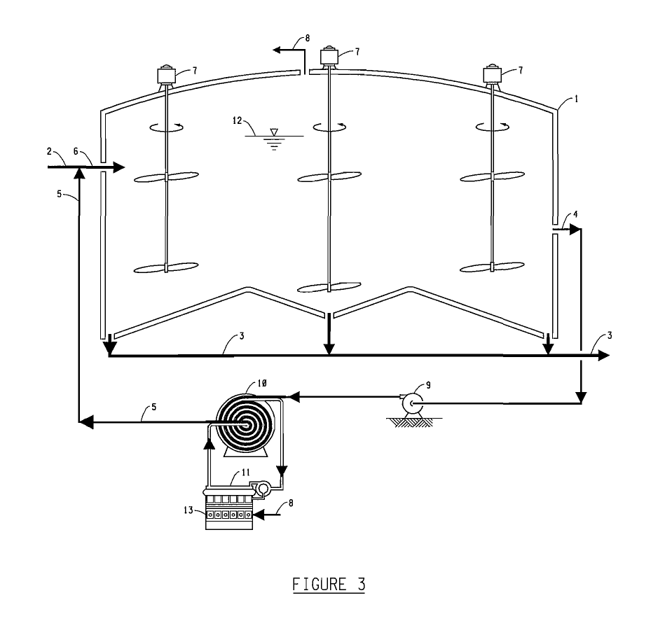

As shown in FIGS. 1, 2 and 3, the preferred reactor or digester 1 is a continuous- or intermittent-feed/draw, completely-mixed, single-stage anaerobic reactor 1. The digestion process takes place under anaerobic conditions where there is 0 mg/L dissolved oxygen present or an absence of oxygen. The inventors preformed the method of the present invention in a full-scale test digester 1 to determine its viability. The digester 1 used consists of a cylindrical tank (95-feet in diameter) with a waffle bottom and fixed top. The digester 1 used has a total volume equal to approximately 1.97 million gallons or 7,457 m³. The height of the digester 1 is 37 feet. The active volume of the digester 1 is approximately 1.8 million gallons or 6,814 m³. The digester 1 is cylindrical, constructed of reinforced concrete and is totally enclosed except for its inlet ports for feed sludge, outlet ports for treated biosolids, outlet port 8 for biogas, and its sludge recirculation system. Methane gas is produced from the digester and exits the digester through the roof into the digester gas transfer pipe that conveys the gas to the engines/turbine to fuel the engine-/turbine-driven generators 13 to produce electricity, used both onsite and sold to the power grid. As shown in FIG. 2, digester feed (inflow) 2 is pumped through a manifold that preferably consists of three inlet valves along one side of the digester. As is also shown in FIG. 2, digested sludge (outflow) 3 is withdrawn from 7 points. To minimize short circuiting, six outlet valves are located around the periphery of the digester 1 at a much lower elevation than the inlet valves and one pipe draws digested sludge from the center of the digester bottom. Sludge is pumped into the digester 1 either intermittently, semi-continuously or continuously. To maintain constant volume (the liquid level 12 is shown in FIGS. 1 and 3), effluent is pumped out of the digester at the same or a similar rate and over the same cycle as feed sludge is introduced into the digester. The mean cell residence time is a function of total active volume of the digester 1 divided by the feed rate, since the reactor 1 is completely mixed the total solids concentration is the same for the discharged treated sludge as it is for the untreated, feed sludge.

The full-scale test digester 1 used by the inventors for their experimental test run had been recently upgraded with a fixed cover and four draft tube mixers 7, one in the center and three evenly spaced around the digester. According to a lithium tracer study conducted, the digester mixing efficiency was greater than 90%, and as such is considered by the inventors to constitute a completely mixed digester as the term is used in the art. Temperature tests also indicated good mixing in the digester as temperature was found to be uniform throughout the digester 1. The preferred mechanical draft tube mixers 7 were made by WesTech Engineering, Inc. The mixers 7 are operated continuously. Mixers 7 can be operated in both reverse (draw from top and discharge to bottom) and forward modes. The mixers 7 were operated in the reverse mode most of the time during the day. As shown in FIG. 1, one mixer 7 is placed in the center of the digester 1 and the other three mixers 7 are radially spaced from the center mixer by 35 feet and equally, diametrically spaced from each other.

According to the preferred form of the invention, the anaerobic digester 1 is fed with primary sludge, thickened pure oxygen waste activated sludge, and trucked non-hazardous high-strength organic wastes for co-digestion. Waste activated sludge was thickened with gravity belt thickeners. The feed sludge could have a total solids concentration greater than 10% and as much as 20%, although for the test the total solids concentration of the feed sludge was less than or equal to 10%. Trucked non-hazardous high-strength wastes included: fats, oils and greases (grease trap wastes), animal processing waste, liquid organic wastes (food industry waste including dairy and winery), and post-consumer food waste preprocessed using an innovative process which is the subject of U.S. Pat. No. 7,410,583, the contents of which are hereby incorporated by reference. According to the present invention, waste activated sludge can make up 50%, or likely higher, of the input sludge to be treated in the reactor, and still meet Class B standards at the lower mean cell residence time. This represents a significant and unexpected development in the art. The inventors are unaware of any continuously-fed (as opposed to a batch-type process), single-stage, thermophilic anaerobic digestion process that can be run at a mean cell residence time of less than 15 days and accept input sludge that contains as much as 50% waste activated sludge and meet Class B performance standards.

Methane gas is produced during the anaerobic digestion of the sludge and is used to fuel internal combustion engines and a turbine that drive large (2.2-4.5 MW) generators. The engines and turbine are water cooled through an engine/turbine's cooling water jacket. Hot water is pumped from this cooling water jacket through a heat exchanger 10 to maintain the elevated temperature of the anaerobic digestion system. The preferred heat exchanger 10 is a spiral water heat exchanger 10. The heat supplied to the hot water loop 11 is supplied by engine-driven generators 13 and/or a hot water boiler. Sludge from the digester 1 is pumped through a recirculation conduit through the heat exchanger 10 and reintroduced into the tank through the same inlet as the feed sludge. The sludge recirculation pump 9 is preferably located before the heat exchanger in the recirculation system. Temperature in the digester 1 can be maintained by increasing or decreasing the hot water flow to the heat exchanger 10. Temperature sensors monitor the heat exchanger inlet and outlet sludge temperature. The hot water control valve modulates to increase or decrease of flow through the heat exchanger 10. If the heat exchanger discharge temperature is lower than the set point, the hot water flow to the heat exchanger 10 is increased, allowing more heat to be transferred from the hot water to the recirculating digester sludge, raising the temperature of the recirculating sludge. The recirculated sludge is withdrawn from a draw-off 4 on one side of the digester at a lower level, pumped through the heat exchanger 10, and returned through a recirculation return 5 to the opposite side of the digester along with the feed sludge in a combined digester feed 6 at a higher level. A control valve regulates the flow of hot water to the heat exchanger on one side with digesting sludge being pumped countercurrent to the hot water by the recirculation pump. The heat exchanger 10 used for the test was a spiral heat exchanger with 3.4 Million BTU/Hr capacity made by Alfa Laval, Inc.

### Testing

As noted above, the inventors conducted a full-scale anaerobic digestion test using the 1.97 million gallon digester at the East Bay Municipal Utility District's Main Waste Water Treatment Plant (EBMUD MWWTP) over an extended period of 15 months. The test included three periods: 1) a Baseline Period during which baseline data were collected for comparison purposes later, 2) an Acclimation Period during which the test digester MCRT was slowly decreased from over 30 days to the target range of 10 to 15 days, and 3) two spaced apart Steady-State Periods during which the test digester was operated at 10-15 days MCRT and 50° C. During testing the MCRT might fluctuate on a daily basis above or below the target range, but during the Steady-State Periods the average MCRT was between 10-15 days. The Steady-State Periods occurred in two periods (Periods I & II). Each period lasted two consecutive months which amounted to 4 to 5 full retention cycles at the lower mean cell residence time. Period I was during wet and cold (winter) weather and Period II was during dry and warmer (summer) weather. The inventors have noticed that feed sludge characteristics may also change in wet and dry seasons so it was important to test the process at two different times for this reason as well.

Digester parameters were closely monitored and samples collected throughout the testing period. Analysis of all the samples was conducted by the East Bay Municipal Utility District's California State accredited environmental testing Laboratory. Fecal coliform testing was conducted under the Standard Methods (SM)(18), 9221E—reported as MPN/100 mL; EC medium with Lauryl Tryptose Broth, 6 hour maximum holding time. Total Solids measurements were conducted under SM(20) 2540B; volatile solids under EPA 160.4 (EBMUD modified); total volatile acids under SM(20) 5560C; total alkalinity as CaCO₃ under SM(20) 2320B; ammonia as Nitrogen under SM(20) 4500 NH₃-B, C; and chemical oxygen demand under SM(20) 5220D. Both TS and VS results were reported as a percentage weight of the wet sample.

Field measurements included the pH of sludge in the digester (Handheld pH meter by Extech Instruments, Model CL200A); and carbon dioxide percentage of the biogas vented from the digester (Handheld Fyrite Gas Analyzer by Bacharach, Inc., Model 11-9026).

Biogas production was continuously measured. CO₂ levels in the biogas were measured 5 times a week and the presence of H₂S in the biogas was measured weekly. The foam level in the digester was continuously measured with radar. The digester's liquid level was continuously measured hydrostatically. A resistance temperature detector continuously measured the digester temperature.

Mean cell residence time was calculated daily based on feed sludge rates. The feed sludge fecal coliform content and total solids amount was measured twice a week. Originally the samples were taken as grab samples, but during the testing the sampling procedure was changed to a time composite of 5-minute grab samples over a 30-minute period. The feed sludge total solids and volatile solids were also measured at least twice a week as a time composite of 4-hour grabs over a 24-hour period. The chemical oxygen demand of the feed sludge was also measured one to two times a week as a time composite of 4-hour grabs over a 24-hour period.

Total alkalinity as CaCO₃ of the sludge in the digester was measured at the heat exchanger recirculation pump 5 times a week. Total volatile acids was also measured at the heat exchanger recirculation pump 5 times a week. The ammonia content of the sludge in the digester was also measured at the heat exchanger recirculation pump weekly and total solids and volatile solids was measured twice a week at this same point.

The digested sludge fecal coliform content and total solids amount was measured twice a week. These samples were taken as grab samples. The digested sludge total solids and volatile solids were also measured at least twice a week as a time composite of 4-hour grabs over a 24-hour period. The chemical oxygen demand of the digested sludge was also measured one to two times a week as a time composite of 4-hour grabs over a 24-hour period.

The following methods were used to calculate the test digester's key process performance parameters.

Mean Cell Residence Time was calculated using the following formula:

$$M C R T ( days ) = \frac{V \times {TS}_{TestDigester}}{q \times {TS}_{DigestedSludge}} = \frac{V}{q} \qquad ( 1 )$$

where
V=Test digester's active volume, 6,814 m³ (1.8 million gallons)
TS_{TestDigester}=concentration of total solids in the test digester (in %)
TS_{DigestedSludge}=concentration of total solids in test digester digested sludge (in %)
q=Test digester's daily feed rate, m³/day
   For this study, MCRT equals to hydraulic retention time (HRT) since TS_{TestDigester}=TS_{DigestedSludge} with the complete-mix test digester.

Volumetric Organic Loading Rate was calculated for both VS loading rate and

COD loading rate using:

$$VSLoadingRate ( kg / {m}^{3} / d ) = \frac{{VS}_{FeedSludge} \times 10}{HRT} \qquad ( 2 )$$

where
VS=Volatile solids concentration in feed sludge (% weight of wet sample)
10, conversion factor for converting VS from % to kg/m³ (assuming a feed sludge density of 1,000 kg/m³), i.e., VS concentration (kg/m³)=VS concentration (%)×10

$$CODLoadingRate ( kg / {m}^{3} / d ) = \frac{{COD}_{FeedSludge}}{HRT} \qquad ( 3 )$$

where
COD=COD concentration in feed sludge (kg/m³)

Total Volatile Acid to Total Alkalinity Ratio was calculated using the following formula:

$$\frac{TVA}{TALK} Ratio = \frac{TotalVolatileAcids ( TVA )}{TotalAlkalinity ( TALK )} \qquad ( 4 )$$

Geometric Mean of Fecal Coliform Density was calculated using the method described in Control of Pathogens and Vector Attraction in Sewage Sludge (Page 37 of EPA/625/R-92/013, July 2003) that takes a geometric mean of samples collected from a 4-week running period at a frequency of twice per week. The number of samples collected from a 4-week running period for this study ranged from 3-11 samples, with a median of 8 samples.

The following calculation steps were followed:
Convert the fecal coliform density from a wet basis (in laboratory reporting) to a dry weight basis by using the following equation (Page 27 of EPA method 1680, EPA 2006)

$$MPN / gTS ( dryweight ) = \frac{MPN / mL ( wetweight )}{PercentTS ( expressedindecimal )} \qquad ( 5 )$$

Calculate Log₁₀ (fecal coliform density) for each sample collected
Calculate the moving average (arithmetic) of the Log₁₀ (fecal coliform density) for samples collected over a 4-week running period
Geometric mean=anti-log of the arithmetic averages
   The detection limit was used whenever fecal coliform results were below the detection limit (non-detects) in the calculations above.

Fecal Coliform Log Reduction was calculated as follows:

Fecal Coliform Log Reduction=Log₁₀(geometric mean of fecal coliform density in Feed Sludge)−Log₁₀(geometric mean of fecal coliform density in Digested Sludge) (6)

Volatile Solids Reduction was calculated using the Van Kleeck Method and Approximate Mass Balance Method described in Appendix C—Determination of Volatile Solids Reduction by Digestion from EPA's Control of Pathogens and Vector Attraction in Sewage Sludge (July 2003). The Simple Moving Average (SMA) of total solids and volatile solids in both feed sludge and digested sludge over a 2-week period was used in Equations 7 and 8.

### Approximate Mass Balance Method:

$$VSR ( \% ) = ( 1 - \frac{{VS}_{DigestedSludge}}{{VS}_{FeedSludge}} ) \times 100 \qquad ( 7 )$$

### Van Kleeck Method:

$$VSR ( \% ) = \frac{\frac{VS}{TS} FeedSludge - \frac{VS}{TS} DigestedSludge}{\frac{VS}{TS} FeedSludge - \frac{VS}{TS} FeedSludge \times \frac{VS}{TS} DigestedSludge} \qquad ( 8 )$$

where
TS or VS=Total solids or volatile solids concentration (in % weight of wet sample)

Biogas Yield was calculated using the following two methods:

Biogas yield per kilogram of dry TS applied to the test digester

$$BiogasYield ( {m}^{3} / {kgTS}_{applied} ) = \frac{{BiogasProduction}_{TestDigetser}}{q \times ( {TS}_{FeedSludge} \times 10 )} \qquad ( 9 )$$

Biogas yield per kilogram of VS reduced by the test digester

$$BiogasYield ( {m}^{3} / kgVSR ) = \frac{{BiogasProduction}_{TestDigester}}{q \times ( {VS}_{FeedSludge} \times 10 ) \times {VSR}_{TestDigester}} \qquad ( 10 )$$

where
Biogas production=Total daily biogas production from test digester in standard m³/day (Standard condition of the EBMUD gas meter readings is at 70° F. (21.1° C.) and 14.7 psi.)
q=daily feed sludge flow rate to the test digester (m³/day)
10 is the conversion factor for % to kg/m³ of TS and VS
VSR was calculated using the Approximate Mass Balance Method

Feed sludge TS varied from 2.1% to 10.0% with the majority of data between 4-6% over the entire testing period. The average of the TS was 5.1%±1.1%, and 4.0%±1.0% for VS. VS accounted for 79%±5% of the TS in the feed sludge.

In addition to the TS and VS which are often used for municipal wastewater solids, COD was monitored to determine the organic strength of the feed sludge. Similarly, the feed sludge COD also varied significantly over the entire testing period; ranging from 29 to 177 g/L, with an average of 89±29 g/L. The composition (types of feed sludge used) and characteristics of the feed sludge are shown in Table 3 below. Feed sludge TS, VS, and COD concentrations during 10- to 15-day MCRT Periods I and II were comparable to the entire testing period.

The VS and COD loading rates applied to the test digester were calculated using Equations 2 and 3 respectively and were varied.

The average VS loading rate was 2.4±0.9 kg VS per cubic meter of active digester volume per day (kg/m³/day) throughout the entire testing period. The VS loading rate increased as the MCRT decreased due to the increase in waste applied to the test digester. The VS loading rates during Periods I and II (3.1±1.0 and 2.9±0.9 kg/m³/day, respectively) were both higher than loading rates in the Baseline Period (1.5±0.3 kg/m³/day). The VS loading rates during Periods I and II were significantly higher than the typical design sustained peak loading rate range for stable mesophilic digesters for municipal sludge digestion, 1.9-2.5 kg VS/m³/day (or 0.12 to 0.16 lb VS/ft³-day), and comparable to the recommended maximum VS loading rate limit of 3.2 kg VS/m³/day (Water Environment Foundation (WEF) and the American Society of Civil Engineers (ASCE) (1998) Design of Municipal Wastewater Treatment Plants (4^{th} ed.) WEF Manual of Practice 8, ASCE Manual and Report on Engineering Practice No. 76. Volume 3. Virginia: WEF.).

Comparing the COD loading rate applied to the test digester to COD loading in a typical complete-mix anaerobic digester at 30° C. (between 1 to 5 kg COD/m³-day) (G. Tchobanoglous, F. L. Burton and H. D. Stensel New York: McGraw-Hill. Metcalf & Eddy, Inc. (2003) Wastewater Engineering—Treatment and Reuse (4^{th} ed.)), the COD loading rate over the entire full-scale testing period (6±2 kg/m³/day) substantially exceeded that of typical mesophilic anaerobic digesters.

Temperature was continuously monitored and recorded in the test digester. Change in digester temperature has been reported as the most significant impact on the activities of anaerobes and efficiency of digester operation (Gerardi, 2003). The test digester was maintained within 2° C. of the target temperature in the baseline and the acclimation phases, but dropped below 48° C. for several days during Period I (Winter) and for some days between Periods I and II, but remained within the target temperature range during Period 2 (Spring/Summer). Digester temperature drops were expected during the winter season with lower ambient temperatures resulting in decreased feed sludge temperature and increased digester heat loss. The increased digester feed rate also created an increased requirement for heat and the drops observed in test digester temperature over these periods could have been a combined result of these factors. The ability of the process to maintain a desired thermophilic temperature under consistently low MCRT operation during winter months was further impacted by the limited capacity of the test digester heat exchanger (3.4 MMBTU/hr).

Despite the temperature drops that occurred during Period I, the digester performance data showed that the requirements were met by the test digester. More consistent temperatures could likely be maintained with the installation of a new heating system for preheating raw feed sludge and a new turbine that would provide more reliable recovered heat for digester heating.

The total volatile acids, total alkalinity, and ammonia concentrations were measured routinely. The total volatile acid-to-total alkalinity ratio (TVA/TALK) has been noted as a key control parameter for maintaining a proper digester operation (Gerardi, 2003). Digester stability was monitored largely in part by tracking TVA/TALK (calculated using Equation 4), where the target acceptable ratio was set at <0.2 for this study. Chemical addition was not used for pH control in the test digester. Studies have shown that digester pH is mostly the result of the TVA/TALK ratio, but pH is the last indicator to change when a digester is upset (Gerardi, 2003). For this reason, pH resulting from the digestion process was only measured occasionally for reference, using a laboratory calibrated handheld pH meter. The measured pH was in the range of 7.6 to 7.9 and was higher than the optimal 6.8-7.2 range for methanogens. The high pH measured in this study was a result of CO₂ loss occurring between the time of sampling and measurement. The pH measured this way could be 0.5 pH units higher than the pH inside the digester. In addition, digester pH is higher in thermophilic digesters (often above 7.5) than the mesophilic digesters (Gray and Hake, WERF (2004) Pathogen Destruction Efficiency in High-Temperature Digestion; Willis, et. al, The State of the Practice of Class-A Anaerobic Digestion: Update for 2005. WEFTEC (2005) Washington, D.C. (October-November 2005)).

Despite the variation of TS, VS and COD in the feed sludge, concentrations were relatively constant in the digested sludge from the test digester over the entire testing period (measured in the test digester's drawoff line). The average TS was 2.7%±0.3%, VS 1.6%±0.2% and COD 29.5±6 g/L for the test digester digested sludge. The volatile solids reduction achieved by the test digester was calculated with the Approximate Mass Balance and Van Kleeck methods. The VSR was consistently above the EPA 503 vector control requirement for greater than 38% reduction throughout the full scale test.

Biogas production is an indicator of the anaerobic process performance. Biogas production from the test digester was monitored continuously and averaged daily. Biogas production increased significantly from 180 scfm in the Baseline Period to 480±60 scfm in Period 1 and 600±130 scfm in Period II, due to the increased feed to reduce MCRT. Higher biogas production in Period II than Period I was due to a higher organic loading rate applied to the test digester during Period II. In addition, fats, oils and greases (wastes with high biogas yield) were added to the test digester starting after Period I, but prior to Period II.

Carbon dioxide (CO₂) content was measured to monitor biogas quality. The main components of digester gas are CO₂ and methane gas (CH₄), where low CO₂ will correspond to high CH₄ content in a typical healthy digester. The CO₂ content during the study averaged 34%±2% from the test digester. This is slightly better than the typical CO₂ content in biogas from anaerobic digestion of municipal sludges at 35-40% (by volume) (Gerardi, M. H., John Wiley & Sons, Inc. (2003) The Microbiology of Anaerobic Digesters).

Biogas yield was calculated as cubic meters of biogas generated per kilogram of dry solids (m³/kg dry TS) of feed sludge applied to the test digester (Equation 9). Compared to literature values, the biogas yield from the test digester (0.82±0.28 m³/kg dry TS) was in the range reported as typical for fats (1-1.25 m³/kg dry TS), proteins (0.6-0.7 m³/kg dry TS) and carbohydrates (0.7-0.8 m³/kg dry TS). (Renewable Energy Concepts: http://www.renewable-energy-concepts.com/english/green-energy-concepts.html)

Biogas yield was also calculated as cubic meters of biogas generated per kilogram of VS reduced (m³/kg VSR, Equation 10) for comparison to typical numbers used for evaluating digester performance. The VS reduction was calculated for the test digester using the Approximate Mass Balance method. The biogas yield by test digester over the entire testing period was 1.78±0.67 m³/kg VSR, much higher than the typical 0.8 to 1 m³/kg (13-18 ft³/lb) of VS destroyed for anaerobic digesters fed primary and secondary waste activated sludges (Water Environment Foundation (WEF) and the American Society of Civil Engineers (ASCE) (1998) Design of Municipal Wastewater Treatment Plants (4^{th} ed.) WEF Manual of Practice 8, ASCE Manual and Report on Engineering Practice No. 76. Volume 3. Virginia: WEF.). This could be attributed to soluble organics in feed sludge from high-strength waste addition for co-digestion in this study. The biogas yield was higher in Periods I and II (1.77±0.46; 2.25±0.99 m³/kg VSR, respectively) than the Baseline Period (1.39±0.34 m³/kg VSR), possibly due to the higher feeding rates during Periods I and II.

Fecal coliform density in the feed sludge varied from 33 to 9.0 logs (logarithmic scale), with an average (arithmetic mean) of 7.0±1.0 logs during the entire testing period. Feed sludge fecal coliform density during Periods I and II was 6.9±0.8 and 7.5±0.7 logs, respectively.

Fecal coliform density in the test digester's digested sludge varied from −0.2 to 6.8 logs with an average of 2.5±1.3 logs. During the entire testing period, only one sample collected from the digested sludge showed a fecal coliform level (6.8 logs) higher than the 2,000,000 (6.3 logs) MPN/g dry TS requirement for Class B biosolids. This sample was collected when the test digester was not operated in the low MCRT (10-15 days) range, which indicates that the high result was independent of digester MCRT, and was likely an outlier.

Despite the variation in feed sludge, the geometric mean calculated over a 4-week running average, was consistently well below the 2,000,000 MPN/g dry TS requirement for Class B biosolids. During both Periods I and II when the test digester's MCRT was 10-15 days, fecal coliform density in the treated sludge averaged 2.8±0.9 and 3.4±1.1 logs, respectively.

The test of the present invention exceeded the required fecal coliform and volatile solids reductions for Class B biosolids with stable digester operation, and as such the municipality treatment plant where the test was conducted has received approval as a site-specific Process to Significantly Reduce Pathogens—equivalent process, the first ever granted by the EPA since the requirements were set in place in 1993. The process parameters and results are shown in Table 1, and are summarized as follows:
1. The Low MCRT Process provided a more than 4-log (base 10) fecal coliform reduction, and fecal coliform density in the digested sludge was approximately 3-log below the 2 million most probable number/g dry TS requirement for Class B biosolids.
2. Volatile solids reduction averaged 55% or higher: consistently higher than EPA requirement of 38% or more.
3. More than three times the biogas was produced with 10-15 days MCRT operation compared to Baseline data when the test digester was operated with a 20-44 day MCRT. Biogas yield was also higher than that of the Baseline period.
4. The Low MCRT Process allowed a significantly higher organic loading rate than that for the Baseline period as well as typically seen in digesters for treating municipal wastewater solids at mesophilic temperatures.

TABLE 1
EBMUD Low MCRT Process Operational and Performance Data

| | | | | 10-15 Days MCRT Operation | | | |
|---|---|---|---|---|---|---|---|
| Entire Test Period | | Baseline Period | | Period I - Wet Winter | | Period II - Dry Summer | |
| Range (Min-Max) | Mean ± SD | Range (Min-Max) | Mean ± SD | Range (Min-Max) | Mean ± SD | Range (Min-Max) | Mean ± SD |

Test Digester Feed Sludge

| | | | | | | | | |
|---|---|---|---|---|---|---|---|---|
| Daily Feed Sludge Volume | 23-194 | 109 ± 31 | 41-96 | 74 ± 12 | 83-194 | 133 ± 28 | 80-180 | 139 ± 24 |
| (kgpd)⁽¹⁾ | | | | | | | | |
| Feed Sludge Total Solids (%) | 2.1-10.0 | 5.1 ± 1.1 | 3.4-6.6 | 4.7 ± 0.8 | 3.1-10.0 | 5.3 ± 1.5 | 2.1-7.6 | 4.9 ± 1.0 |
| Feed Sludge Volatile Solids (%) | 1.2-8.4 | 4.0 ± 1.0 | 2.6-5.7 | 3.9 ± 0.7 | 2.5-8.1 | 4.2 ± 1.2 | 1.2-6.2 | 3.8 ± 0.9 |
| Feed Sludge COD (mg/L) | 29,300-177,000 | 88,790 ± 28,690 | 67,500-77,000 | 71,330 ± 5,010 | 33,800-104,000 | 75,880 ± 18,790 | 56,900-154,000 | 81,210 ± 23,140 |
| VS Loading Rate (kg | 0.5-6.8 | 2.4 ± 0.9 | 0.8-2.2 | 1.5 ± 0.3 | 1.7-5.7 | 3.1 ± 1.0 | 0.9-5.3 | 2.9 ± 0.9 |
| VS/m³/d)⁽²⁾ | | | | | | | | |
| COD Loading Rate (kg | 2-13 | 6 ± 2 | 2-3 | 3 ± 1 | 3-9 | 6 ± 2 | 4-13 | 7 ± 2 |
| COD/m³/d)⁽²⁾ | | | | | | | | |
| Log10(Fecal Coliform Density, MPN/g TS dry) | 3.7-9.0 | 7.0 ± 1.0 | 4.4-7.6 | 5.9 ± 1.4 | 4.4-8.1 | 6.9 ± 0.8 | 6.1-9.0 | 7.5 ± 0.7 |

Test Digester Operation

| | | | | | | | | |
|---|---|---|---|---|---|---|---|---|
| Detention Time (days) | 9-78 | 18 ± 7 | 20-44 | 26 ± 5 | 9-22 | 14 ± 3 | 10-22 | 13 ± 3 |
| Daily Operating Temperature | | | | | | | | |
| (° C.) | 47-52 | 50 ± 0.9 | 49-51 | 50 ± 0.2 | 47-50 | 49 ± 1.0 | 48-51 | 50 ± 0.6 |
| (° F.) | 116-126 | 122 ± 1.6 | 121-123 | 122 ± 0.4 | 116-123 | 120 ± 1.9 | 119-124 | 122 ± 1.2 |

Test Digester Digested Sludge

| | | | | | | | | |
|---|---|---|---|---|---|---|---|---|
| Digested Sludge Total Solids (%) | 2.0-3.7 | 2.7 ± 0.3 | 2.5-2.6 | 2.5 ± 0.0 | 2.7-3.7 | 3.0 ± 0.3 | 2.0-3.1 | 2.5 ± 0.2 |
| Digested Sludge Volatile Solids (%) | 1.2-2.1 | 1.6 ± 0.2 | 1.6-1.7 | 1.6 ± 0.1 | 1.7-2.1 | 1.9 ± 0.1 | 1.2-1.9 | 1.5 ± 0.1 |
| Digested Sludge COD (mg/L) | 20,700-65,900 | 29,550 ± 5,960 | 28,800-31,300 | 30,230 ± 1,290 | 27,400-38,400 | 32,390 ± 3,540 | 22,800-35,400 | 27,500 ± 3,040 |
| Log10(Fecal Coliform Density, MPN/g TS dry) | −0.2-6.8 | 2.5 ± 1.3 | 1.2-3.7 | 2.9 ± 1.2 | 0.7-4.2 | 2.8 ± 0.9 | 1.8-5.5 | 3.4 ± 1.1 |

Test Digester Performance

| | | | | | | | | |
|---|---|---|---|---|---|---|---|---|
| VSR (%), Van Kleeck | 48-74 | 60 ± 5 | 57-63 | 60 ± 2 | 51-64 | 58 ± 3 | 49-61 | 55 ± 3 |
| VSR (%), Approximate Mass | 52-70 | 59 ± 3 | 57-59 | 58 ± 1 | 52-61 | 57 ± 2 | 55-63 | 59 ± 2 |
| Balance | | | | | | | | |
| Fecal Coliform Log Reduction | 2.4-6.3 | 4.5 ± 0.8 | NA⁽³⁾ | 3.0⁽³⁾ | 3.5-5.1 | 4.2 ± 0.4 | 3.3-4.5 | 4.1 ± 0.3 |

Test Digester Chemistry

| | | | | | | | | |
|---|---|---|---|---|---|---|---|---|
| Total Volatile Acids (mg/L) | 140-2,800 | 840 ± 560 | 200-420 | 300 ± 70 | 420-2,800 | 1,310 ± 650 | 180-2,800 | 1,320 ± 690 |
| Total Alkalinity | 5,600-13,000 | 9,400 ± 1,280 | 9,700-11,000 | 10,510 ± 530 | 8,200-11,000 | 9,020 ± 800 | 7,300-8,900 | 8,090 ± 410 |
| (as CaCO₃) (mg/L) | | | | | | | | |
| TVA/TALK Ratio | 0.01-0.38 | 0.09 ± 0.07 | 0.02-0.04 | 0.03 ± 0.01 | 0.04-0.34 | 0.15 ± 0.08 | 0.02-0.38 | 0.17 ± 0.09 |
| Ammonia (mg/L, as N) | 1,750-3,240 | 2,520 ± 480 | 2,480-3,240 | 3,030 ± 280 | 2,120-2,610 | 2,420 ± 200 | 1,800-2,050 | 1,930 ± 80 |

Test Digester Biogas Production

| | | | | | | | | |
|---|---|---|---|---|---|---|---|---|
| Biogas Production (scfm)⁽⁴⁾ | 110-810 | 400 ± 150 | 125-225 | 180 ± 20 | 330-580 | 480 ± 60 | 320-810 | 600 ± 130 |
| Biogas Quality (% CO₂) | 25-40 | 34 ± 2 | 32-35 | 33 ± 1 | 29-40 | 34 ± 2 | 26-38 | 33 ± 3 |
| Biogas Yield (m³ biogas/kg dry TS applied) | 0.31-2.25 | 0.82 ± 0.28 | 0.42-0.93 | 0.60 ± 0.13 | 0.34-1.13 | 0.79 ± 0.19 | 0.55-2.25 | 1.00 ± 0.35 |
| Biogas Yield (m³ biogas/kg VSR)⁽⁵⁾ | 0.64-7.21 | 1.78 ± 0.67 | 0.99-2.33 | 1.39 ± 0.34 | 0.71-2.49 | 1.77 ± 0.46 | 1.10-7.21 | 2.25 ± 0.99 |

Mean—Arithmetic Mean (average).
SD—standard deviation.
⁽¹⁾kgpd, thousand gallons per day. Kgpd * 3.7854 = m³/d
⁽²⁾Per m³ of active volume of the test digester (1.8 million gallons or 6,814 m³). kg/m³-d × 62.4280 = lb/10³ ft³-d
⁽³⁾Difference between geometric mean of all 5 samples collected for the feed and digested sludge from Apr. 22 to May 8, 2008.
NA—not available since there was only one data point.
⁽⁴⁾Standard condition of the EBMUD MWWTP's digester gas meter readings is at 70° F. (21.1° C.) and 14.7 psi.
⁽⁵⁾VSR using Approximate Mass Balance Method (Equation 10). m³ biogas/kg × 16.02 = ft³ biogas/lb

TABLE 2
EBMUD Site-specific Low MCRT Process as a PSRP Equivalency
Process

| Characteristics | Range/Type |
|---|---|
| Feed Sludge | Primary sludge, waste activated sludge |
| | and non-hazardous high-strength organic |
| | materials with a total solids |
| | concentration less than 10% |
| Digestion Type | Anaerobic |
| Feed and drawdown | Continuously or intermittent |
| Digester Mixing | Continuously |

| Process Parameters | Range/Target |
|---|---|
| Detention Time | Greater than or equal to 240 hours |
| | based on a 10-day moving average |
| Operating Temperature | 50 ± 3° C. |
| Operating pH | 6.5-8.5 standard units |
| Total Volatile Acid to Alkalinity | <0.4 |
| Ratio | |

TABLE 3
Historical Feed Sludge and Biosolids Characteristics of the
EBMUD MWWTP's Anaerobic Digestion System

| Jan. 1 to | | Jan. 1 to | |
|---|---|---|---|
| Dec. 31, 2008 | | Dec. 31, 2009 | |
| Includes Period 1 | | Includes Period 2 | |
| Range⁽¹⁾ | Mean | Range⁽¹⁾ | Mean |

Feed Sludge Characteristics

| | | | | |
|---|---|---|---|---|
| Primary Sludge | 30-47% | 39% | 26-42% | 33% |
| Component (v/v) | | | | |
| Thickened Waste | 31-50% | 41% | 24-41% | 32% |
| Activated Sludge | | | | |
| Component (v/v) | | | | |
| Trucked High-strength | 11-30% | 20% | 21-47% | 35% |
| Wastes Component (v/v) | | | | |
| Total Solids (TS) | 4.1-6.2% | 5.0% | 3.9-6.3% | 5.0% |
| Volatile Solids (VS) | 3.2-4.9% | 4.0% | 2.9-5.1% | 3.9% |

| | |
|---|---|
| Feed Sludge Fecal | 10^{3.7}(min.)-10^{9.0} (max.) (Mean 10^{7.0})^{(a)} |
| Coliform | |
| (MPN/g TS dry) | |

Digested Sludge Characteristics

| | | | | |
|---|---|---|---|---|
| Total Solids (TS) | 2.0-2.6% | 2.3% | 2.0-2.6% | 2.3% |
| Volatile Solids (VS) | 1.2-1.5% | 1.4% | 1.1-1.4% | 1.3% |
| Flowrate (kgpd) | 400-695 | 550 | 440-735 | 600 |

Dewatered Biosolids Cake

| | | | | |
|---|---|---|---|---|
| Total Solids (TS) | 20.4-22.4% | 21.4% | 21.6-24.9% | 23.3% |
| Biosolids (Metric dry | 28-53 | 40 | 27-57 | 41 |
| tons per day) | | | | |
| Fecal Coliform (MPN/g | 10^{2.3}-10^{3.9} | 10^{3.5} | 10^{2.2}-10^{3.0} | 10^{2.8} |
| TS dry)⁽²⁾ | | | | |

TWAS—Thickened Waste Activated Sludge;
v/v—percent by volume
^{(a)}From data collected during the full study period: April 2008 to June 2009.
⁽¹⁾Used 10^{th} percentile for low value and 90^{th} percentile for high value for the range for all parameters except for feed sludge fecal coliform density.
⁽²⁾Monthly geometric mean of samples collected twice per week.

1. A method for treating a waste stream, such as wastewater sludge, comprising:
a. introducing feed sludge into a continuously-stirred, sealed, anaerobic digester, and drawing off sludge from the digester at a rate such that the mean cell residence time for the sludge in the digester is greater than or equal to 10 days, and less than 15 days;
b. maintaining the temperature of the sludge in the digester in the range of from 47° C. to 65° C.; and
c. producing treated sludge having: a volatile solids content that is at least 38% less than the volatile solids content of the feed sludge introduced into the digester, a reduced fecal coliform content that is at least a 2 log (base 10) reduction from the feed sludge introduced into the digester, and where a geometric mean of seven samples of the treated sludge shows that there is no more than 2,000,000 most probable number/gram total solids (dry weight basis) of fecal coliform in the treated sludge.

2. The method of claim 1, wherein:
the digester is completely mixed.

3. The method of claim 1 wherein:
the waste stream is pumped continuously to the anaerobic digester and the treated waste stream is withdrawn from the digester continuously.

4. The method of claim 1 wherein:
the waste stream is pumped intermittently to the anaerobic digester and the treated waste stream is withdrawn from the digester intermittently.

5. The method of claim 1 wherein:
the waste stream is pumped either continuously or intermittently to the anaerobic digester and the treated waste stream is withdrawn from the digester either continuously or intermittently.

6. The method of claim 1, wherein:
the feed sludge introduced into the reactor comprises: primary sludge, waste activated sludge, and trucked non-hazardous high-strength organic wastes.

7. The method of claim 6, wherein:
the trucked non-hazardous high-strength wastes may include: fats, oils and grease (grease-trap type) wastes, animal processing waste, liquid organic wastes, post-consumer food waste, and other biologically-degradable wastes.

8. The method of claim 6, wherein:
the feed sludge consists of up to 50% waste activated sludge.

9. The method of claim 6, wherein:
the feed sludge consists of 24 to 50% waste activated sludge.

10. The method of claim 6, wherein:
the feed sludge consists of 32 to 41% waste activated sludge on average.

11. The method of claim 1, wherein:
the treated sludge has a volatile solids content that is 55% less than the volatile solids content of the feed sludge introduced to the digester.

12. The method of claim 1, wherein:
the treated sludge has a reduced fecal coliform content that is a 4 log (base 10) reduction from the feed sludge introduced to the digester.

13. The method of claim 1, wherein:
the pH of the sludge in the digester is maintained between 6.5 and 8.5 standard units.

14. The method of claim 1, wherein:
the total volatile acid to alkalinity ratio in the digester is less than 0.4.

15. The method of claim 1, wherein:
the temperature of the sludge in the digester is maintained in the range of 47° C. to 53° C.

16. The method of claim 1, wherein:
the feed sludge consists of greater than 50% waste activated sludge.

17. The method of claim 1, wherein:
the feed sludge has a total solids concentration greater than 10%.

18. The method of claim 1, wherein:
the feed sludge has a total solids concentration less than or equal to 10%.

19. The method of claim 1, wherein:
the feed sludge has a total solids concentration of approximately 10%.

20. The method of claim 1, wherein:
the temperature of the sludge in the digester is maintained near 50° C.
